(19) United States
(12) Patent Application Publication
(10) Pub. No.: US 2006/0145779 A1
(43) Pub. Date: Jul. 6, 2006

(54) High frequency circuit

(76) Inventor: Takeshi Furuta, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/521,147

(22) PCT Filed: Aug. 6, 2003
(86) PCT No.: PCT/JP03/10008

§ 371 Date: Sep. 7, 2005

(30) Foreign Application Priority Data
Aug. 6, 2002 (JP) 2002-228188

(51) Int. Cl. H01P 1/15

(52) U.S. Cl. 333/103

(57) ABSTRACT

If an RF signal is to be shut only by open/close of an FET, a path loss in an ON status becomes large and a sufficient isolation cannot be retained in an OFF status, respectively in a high frequency range.

A high frequency circuit having shunt circuits between a high frequency transmission path 13 and GND, has, for example, two shunt circuits 11 and 12 including active elements 14 and 15 and impedance elements (L1, L2, C). These shunt circuits 11 and 12 are configured in such a manner that a parallel resonance circuit of the impedance elements (L1, C) is formed when the active elements 14 and 15 are ON, and a serial resonance circuit of the impedance elements (C, L2) is formed when the active elements are OFF.

### TECHNICAL FIELD

The present invention relates to a high frequency circuit having shunt paths including active elements between a high frequency transmission path and a ground.

### BACKGROUND ART

In a main high frequency circuit such as an ASK (amplitude shift keying) modulator, an active element such as an FET (field effect transistor) is respectively disposed at a high frequency transmission path and a path from the high frequency transmission path to a ground (GND), i.e., a shunt path, and the active elements of these paths are alternately turned on and off to execute a switching operation.

FIG. 12 shows an example of the fundamental structure of a conventional high frequency circuit. In FIG. 12, an FET Q101 is disposed on the side of a high frequency transmission path 101. A capacitor C101, an FET Q102 and a capacitor C102 are serially connected between the high frequency transmission path 101 and a ground on the side of a shunt path 102. Control signals A and AX having opposite phases are applied to the gates of FET's Q101 and Q102 to alternately execute turn ON (close)/OFF (open) operations.

ASK modulation is a scheme in which the modulation is performed in response to an amplitude of an RF (radio frequency) signal. This function can be realized by the same configuration as that of an SPST (single pole single throw) switch.

However, if a transmission frequency is several GHz or higher, particularly 5 to 6 GHz used by an ETC (Electric Toll Collection) system, a wireless home network and the like, there arises problems such that a path loss during ON becomes large because of an OFF capacitance of FET, or an isolation during OFF becomes insufficient. The FET OFF capacitance is capacitive components between the drain and source of FET in the OFF condition. An impedance Z of FET is given by an equation (1):
Z=1/jωCoff, ω=2πf (1)
where Coff is the OFF capacitance of FET. As apparent from the equation (1), it can be understood that the resistance component |Z| becomes smaller in inverse proportion with the frequency f.

FIG. 13 shows an equivalent circuit when the high frequency transmission path 101 is ON (ON of Q101) and the shunt path 102 is OFF (OFF of Q102). The OFF capacitance Coff is sufficiently smaller than the capacitance of the DC cut capacitors C101 and C102 and an ON resistance Ron of FET Q101 is about several Ω. Therefore, the characteristics of the circuit of FIG. 13 are determined dominantly by a power leak by the OFF capacitance Coff. Conversely, while the high frequency transmission path is OFF and the shunt path 102 is ON, FET Q101 of the high frequency transmission path 101 has the OFF capacitance, which leaks a power.

As described above, if an RF signal is to be shut by using only open/close of FET's, it becomes essentially difficult in a high frequency band particularly in view of the transmissive property. Namely, in the high frequency range, a path loss during ON becomes large and a sufficient isolation cannot be acquired during OFF. The Similar problem occurs even in the case of a circuit configuration using not FET but a PIN (positive intrinsic negative) diode.

The present invention has been made in consideration of the above-described issues, and an object of the present invention is to provide a high frequency circuit capable of reducing a path loss and acquiring a sufficient isolation, even in a high frequency range.

### DISCLOSURE OF THE INVENTION

A high frequency circuit of the present invention has a plurality of shunt paths including active elements and impedance elements between a high frequency transmission path and a ground, and the plurality of shunt circuits are arranged to form a parallel resonance circuit of the impedance elements when the respective active elements are ON and a serial resonance circuit when the respective active elements are OFF.

In the high frequency circuit having the above-described configuration, when the respective active elements are ON, the active elements are considered equivalently an ON resistor, and since the ON resistor is sufficiently small in resistance, the ON resistor is considered shorted. Therefore, the plurality of shunt circuits form equivalently a parallel resonance circuit of impedance elements when the active elements are ON. By setting an operation frequency to the resonance frequency, the parallel resonance circuit makes a shunt circuit direction (hereinafter described as a shunt direction) have a high resistance and allows the low loss transmissive property to be obtained in a harmonics transmission path direction (hereinafter described as a through direction). When the respective active elements are OFF and if it is assumed that the OFF capacitance of each active element is sufficiently small, the plurality of shunt circuits form equivalently a serial resonance circuit of impedance elements. By setting an operation frequency to the resonance circuit, the serial resonance circuit makes the shunt direction have a low resistance, and a transmission power in the through direction can be reduced.

### BRIEF DESCRIPTION OF DRAWINGS

FIG. 1 is a circuit diagram showing an example of the structure of a high frequency circuit according to an embodiment of the present invention.

FIG. 2 is a circuit diagram in which turned-ON active elements are represented by ON resistors.

FIG. 3 is an equivalent circuit diagram of a parallel resonance circuit formed when the active elements are turned ON.

FIG. 4 is a circuit diagram in which turned-OFF active elements are represented by OFF resistors.

FIG. 5 is an equivalent circuit diagram of a serial resonance circuit formed when the active elements are turned OFF.

FIG. 6 is a circuit diagram of a specific high frequency circuit according to an embodiment of the present invention.

FIG. 7 is a diagram showing simulation results of the specific high frequency circuit.

FIG. 8 is a circuit diagram of a conventional high frequency circuit modified for high frequency as a comparison example of simulation results.

FIG. 9 is a diagram showing simulation results of the conventional high frequency circuit.

FIG. 10 is a circuit diagram showing an example of the structure of a high frequency circuit according to a modification of the present embodiment of the present invention.

FIG. 11 is a circuit diagram showing an example of a multi-port switch circuit as an application example of the present invention.

FIG. 12 is a circuit diagram showing an example of the structure of a conventional high frequency circuit.

FIG. 13 is an equivalent circuit diagram of the conventional high frequency circuit in an ON status.

### BEST MODE FOR CARRYING OUT THE INVENTION

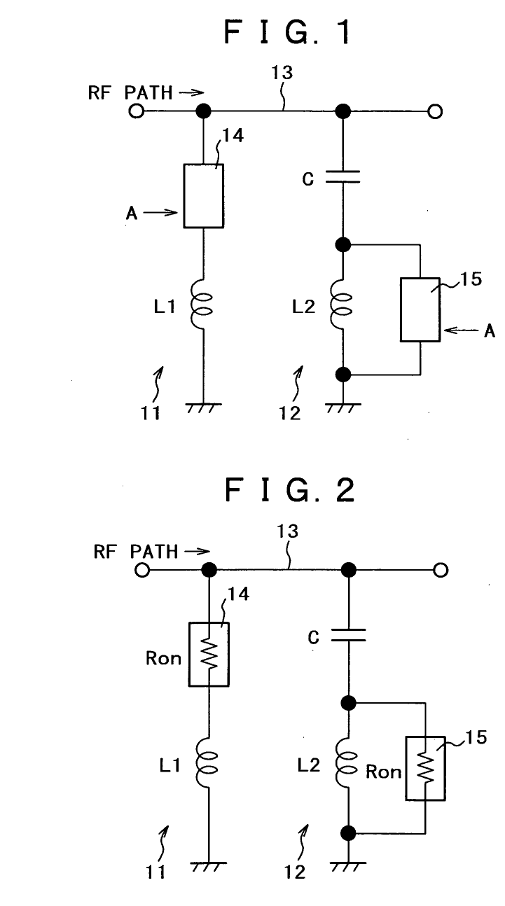

In the following, detailed description of embodiments of the present invention will be given with reference to the drawings. FIG. 1 is a circuit diagram showing an example of the structure of a high frequency circuit according to an embodiment of the present invention.

As seen from FIG. 1, the high frequency circuit of the present embodiment is constituted of a plurality of, e.g., two shunt circuits 11 and 12 each having an active element and an impedance element or elements and implemented on the same substrate. The shunt circuit 11 is constituted of an active element 14 and an inductor L1 serially connected between a high frequency transmission path 13 and a ground. The other shunt circuit 12 is constituted of a capacitor C and an inductor L2 serially connected between the high frequency transmission path 13 and the ground, and an active element 15 connected in parallel to the inductor L2.

In this high frequency circuit, the active elements 14 and 15 are controlled to be turned ON/OFF by a common control signal A. Since only one control line is used for the transmission of the control signal A, the circuit configuration can be simplified. The impedances of the shunt circuits 11 and 12 are changed through ON/OFF of the active elements 14 and 15 to switch between the ON/OFF status of the whole circuit. An FET, a PIN diode or the like may be used as the active elements 14 and 15.

A specific circuit operation will be described below.

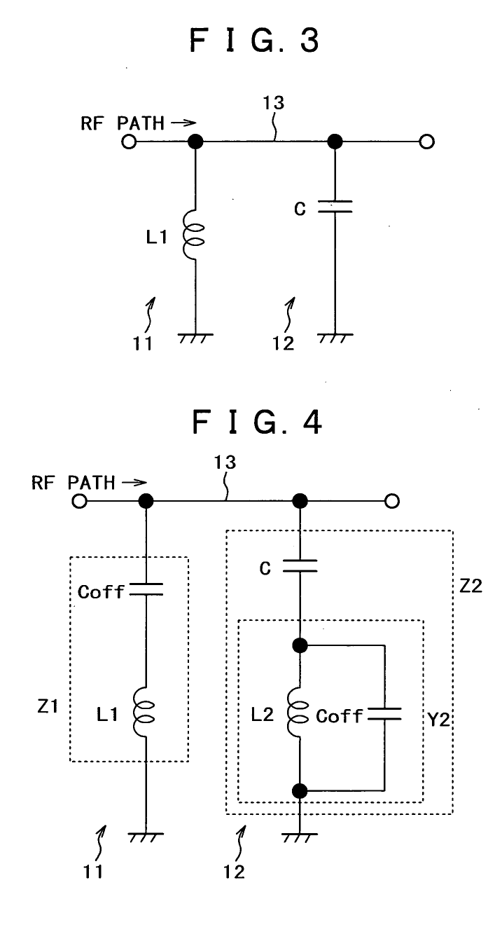

As shown in FIG. 2, when the active elements 14 and 15 are ON (low resistance=Ron status), the high frequency circuit is in an ON status. In this status, the active elements 14 and 15 are considered equivalently an ON resistor Ron. This ON resistor Ron is sufficiently small in resistance and can be considered shorted. Therefore, the high frequency circuit in the ON status is equivalently a parallel resonance circuit of the inductor L1 and capacitor C, as shown in FIG. 3.

An impedance Zon of the parallel resonance circuit is given by the following equation (2):
Zon=1/Yon, Yon=jωL1+jωCZon=jωL1/(1−ω²L1C) (2)
As the values of the inductor L1 and capacitor C, element constants are selected which satisfy the following equation (3):
ω²=1/L1C (3)
, thereby allowing an operation frequency being set to a resonance point (Zon=infinite). Therefore, the shunt direction can be made to have a high resistance and the transmissivity in a through direction (high frequency transmission path) can be improved.

As described above, in the high frequency circuit of this embodiment, the shunt direction can be made to have a high resistance and low loss transmissive property can be realized in the through direction.

On the other hand, as shown in FIG. 4, when the active elements 14 and 15 are OFF (high resistance=Coff status), the high frequency circuit is in an OFF status. In this status, an impedance Z1 of the shunt circuit 11 including the inductance L1 is:
Z1=jωL1+1/jωCoff (4)
If the OFF capacitance Coff is sufficiently small, the impedance Z1 is infinite so that the shunt circuit 11 is negligible.

An admittance Y2 (Y=1/Z) of the parallel circuit constituted of the inductor L2 and the OFF capacitance Coff is given by:
Y2=1/jωL2+jωCoff
An impedance Z2 of the shunt circuit 12 including the parallel circuit is given by:

$$\begin{matrix}Y2 = 1 / j ω C + 1 / Y2 \\ = 1 / j ω C + j ω L2 / ( 1 - {ω}^{2} L2Coff )\end{matrix} \qquad ( 5 )$$

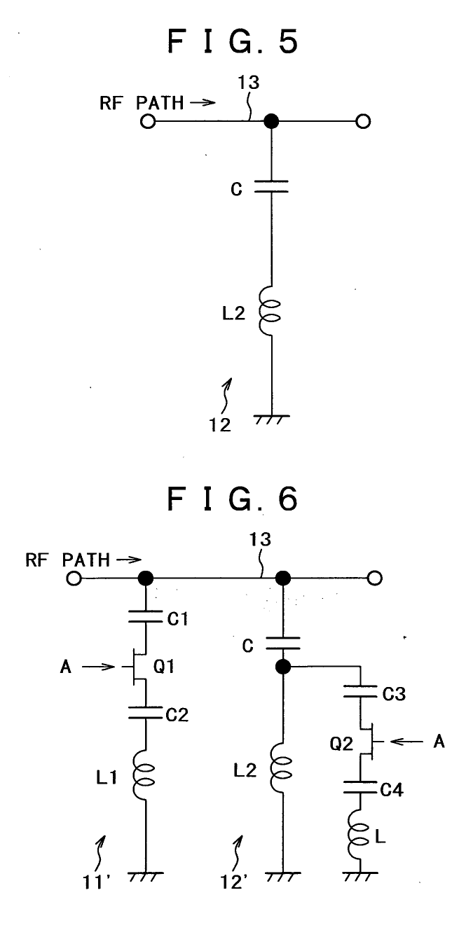

If the OFF capacitance Coff is sufficiently small, the admittance Y2 is only the components of the inductor L2 and the circuit is equivalently a serial resonance circuit of the inductor L2 and capacitor C as shown in FIG. 5.

By substituting Z2=0 in the equation (5), a resonance frequency of the serial resonance circuit is given by:
ω²=1/L2C (6)
By setting the operation frequency to this resonance frequency, the shunt direction can be made to have a small resistance so that the transmission power in the through direction can be lowered and the OFF status of the high frequency circuit can be realized.

However, at the frequency of several GHz or higher, the influence of the OFF capacitance (more correctly, a product ωCoff) cannot be neglected, and an ideal serial resonance circuit of the inductor L2 and capacitor C cannot be realized. Therefore, a resonance point is obtained by solving an impedance Zoff of the whole circuit:
Zoff=1/Yoff, Yoff=1/Z1+1/Z2 (7)

By substituting the equation (3) in the equation (5), the equation (7) can be rearranged to:
Zoff=jωL1(C−Coff)* (L1−L2−L2Coff/C)/(2L2Coff−L1C) (8)
In order to satisfy Zoff=0, element constants are selected which satisfy:
L1/L2−1=Coff/C (9)

As described above, the high frequency circuit having shunt circuits between the high frequency transmission path 13 and ground, has a plurality of, e.g., two shunt circuits 11 and 12 including the active elements 14 and 15 and impedance elements (L1, L2, C). These shunt circuits 11 and 12 are configured in such a manner that a parallel resonance circuit of the impedance elements (L1, C) is formed when the active elements 14 and 15 are ON and a serial resonance circuit of the impedance elements (C, L2) is formed when the active elements are OFF. Accordingly, in the ON status, the low loss transmissive property is obtained at the operation frequency, whereas in the OFF status, the shunt direction can be made to have a low resistance and the transmission power in the through direction can be reduced.

### SPECIFIC EXAMPLE

FIG. 6 is a circuit diagram showing a specific circuit according to the present embodiment. In FIG. 6, like elements to those shown in FIG. 1 are represented by using identical symbols. In this specific example, as active elements 14 and 15, FET's are used, which are made of suitable material for high frequency processing such as GaAs (gallium·arsenic) series material.

Referring to FIG. 6, one shunt circuit 11′ is constituted of a capacitor C1, an FET Q1, a capacitor C2 and an inductor L1, which are serially connected between a high frequency transmission path 13 and a ground. The other shunt circuit 12′ is constituted of a capacitor C and an inductor L2 which are connected between the high frequency transmission path and the ground, and a serial connection circuit of a capacitor C3, an FET Q2, a capacitor C4 and an inductor L3, which are connected in parallel to the inductor L2.

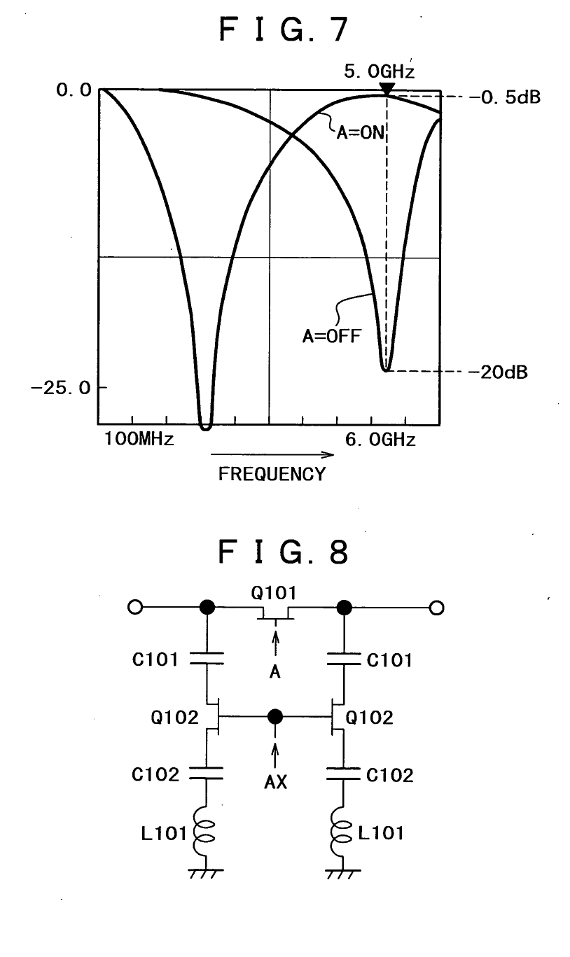

In the high frequency circuit of the above-described specific example, in order to apply a bias to FET's Q1 and Q2, the capacitors C1, C2, C3 and C4 are inserted for DC cut, and the inductor L3 is added for consideration of the inductance in IC bonding wires. FIG. 7 shows simulation results of the high frequency circuit of the specific example under the conditions of, for example, an operation frequency of 5 GHz and the element constants of C=0.95 pF, C1, C2=6 pF, C3, C4=10 pF, Coff=0.4 pF, L1=1.1 nF, L2=0.7 nF and L3=0.4 nF.

As apparent from the simulation results shown in FIG. 7, the high frequency circuit of the specific example has a loss of about 0.5 dB in the ON status and an isolation of 20 dB is retained in the OFF status.

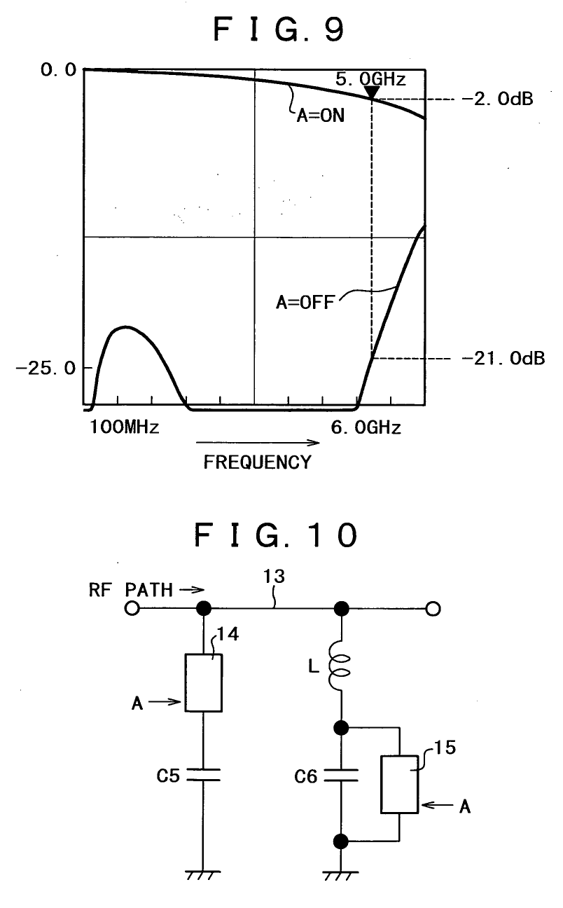

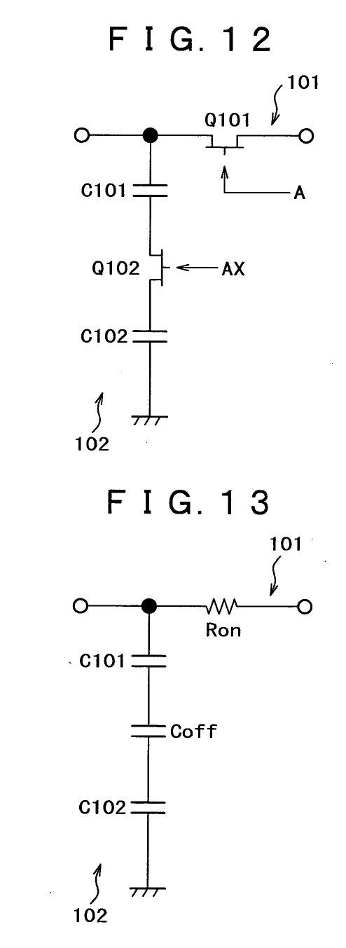

FIG. 9 shows simulation results of a circuit shown in FIG. 8 according to a conventional example used for comparison. The circuit shown in FIG. 8 is obtained by modifying the conventional circuit shown in FIG. 12 for high frequency use. In this example, the circuit constants are C101, C102=3 pF, L104=0.7 nF and Coff=0.4 pF. As apparent from the simulation results shown in FIG. 9, although an isolation in the OFF status is 21 dB, a loss in the ON status is as large as about 2 dB.

As apparent from the comparison result, as compared to the conventional high frequency circuit, although the high frequency circuit of the specific example has an isolation in the OFF status nearly equal to that of the conventional high frequency circuit, the loss in the ON status can be reduced by about 1.5 dB in the high frequency range.

In the circuit example shown in FIG. 1, if all or a part of the inductors L1 and L2 is replaced with the inductance components of bonding wires, the element area of an IC can be reduced. For example, the inductance component of single wire is 0.7 nF, and the inductance component of a parallel connection of two wires is 0.4 nF. Therefore, in the circuit example shown in FIG. 6, the inductors L2 and L3 may be replaced with the inductance components of wires, and an inductor of 0.4 nF may be built in an IC as the inductor L1. In this manner, the element area of IC can be reduced.

### MODIFIED EXAMPLE

In the above-described embodiment, although the two shunt circuits 11 and 12 including the inductors L1 and L2 are used byway of example, the present invention is not limited thereto. As shown in FIG. 10, two shunt circuits including capacitors C1 and C2 may be switched at the same time to obtain similar advantages described above. A circuit arrangement having three or more shunt paths may also be used.

### APPLIED EXAMPLE

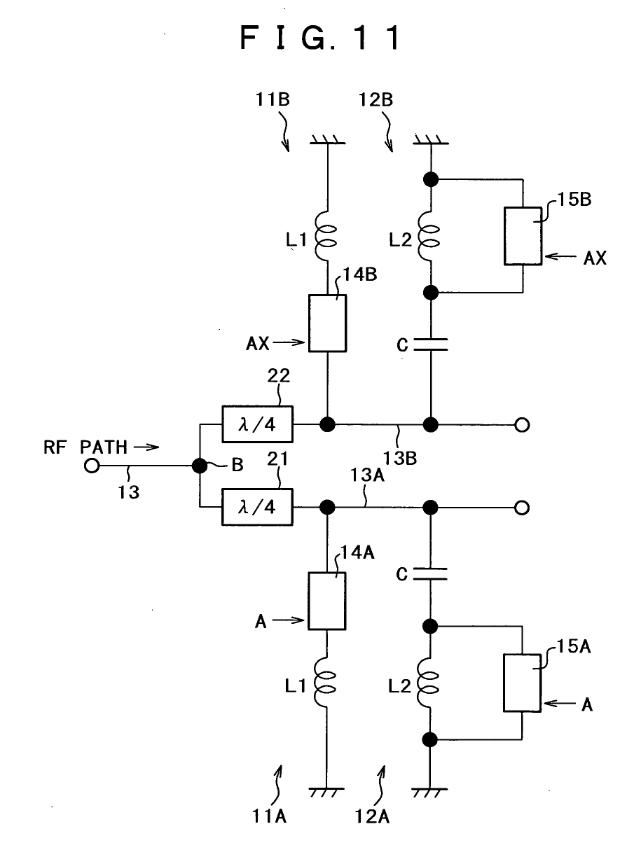

The high frequency circuit of the present embodiment or its modification example described above may be used as an ASK modulator, an SPST switch or the like. A plurality of high frequency circuits of the present embodiment or its modification example may be used to apply to a multi-port switch of SPST switches or the like. A specific circuit example of the multi-port switch is shown in FIG. 11.

Referring to FIG. 11, a high frequency transmission path 13 is branched into two series A and B at a branch point B. Into these two series of a high frequency transmission path 13A and a high frequency transmission path 13B, phase conversion devices 21 and 22 such as strip lines are inserted to shift the phase by λ/4. The phase conversion devices 21 and 22 are inserted in order not to lower an amplitude of an RF signal at the branch point when one of the ports is shorted.

The shunt circuits 11 and 12 shown in FIG. 1 are disposed as shunt circuits 11A and 11B of the A series and shunt circuits 11B and 12B of the B series, between the ground and the two series of the high frequency transmission paths 13A and 13B. Active switches 14A and 15A of the shunt circuits 11A and 12A of the A series are controlled to be turned ON/OFF by a control signal A, whereas active switches 14B and 15B of the shunt circuits 11B and 12B of the B series are controlled to be turned ON/OFF by a control signal AX having an opposite phase to that of the control signal A.

In this applied example, the present invention is applied to a multi-port switch of SPST switches or the like. The present invention is not limited only to this applied example, but the present invention may also be applicable to an ASK modulator or the like.

### INDUSTRIAL APPLICABILITY

As described so far, according to the present invention, a plurality of shunt paths including active elements and impedance elements are connected between the high frequency transmission path and the ground. These shunt circuits are arranged to form a parallel resonance circuit of impedance elements when the active elements are in the ON status and a serial resonance circuit of impedance elements in the OFF status. A path loss can therefore be reduced and a sufficient isolation can be retained, even in the high frequency range.

1. A high frequency circuit characterized by comprising:
a plurality of shunt paths including active elements and impedance elements in between a high frequency transmission path and a ground;
wherein said plurality of shunt circuits form a parallel resonance circuit of said impedance elements when each of said active elements is ON, and a serial resonance circuit of said impedance elements when each of said active elements is OFF.

2. The high frequency circuit according to claim 1 characterized in that:
said active element is a field effect transistor.

3. The high frequency circuit according to claim 2 characterized in that:
said field effect transistor is made of gallium arsenic series material.

4. The high frequency circuit according to claim 1 characterized in that:
said plurality of shunt paths are formed on a same substrate.

5. The high frequency circuit according to claim 1 characterized in that:
an inductor forming said plurality of shunt paths is replaced with inductance components of an IC bonding wire.
